(19) United States
(12) Patent Application Publication
(10) Pub. No.: US 2022/0354295 A1
(43) Pub. Date: Nov. 10, 2022

(54) SYSTEM FOR BREWING A LIQUID

(71) Applicant: CM BREWING TECHNOLOGIES, LLC, Tustin, CA (US)

(72) Inventors: Jakob M. Kucera, Winchester, CA (US); Curtis C. Kucera, Temecula, CA (US); Ryan M. Carter, Irvine, CA (US)

(21) Appl. No.: 17/735,640

(22) Filed: May 3, 2022

Related U.S. Application Data
(60) Provisional application No. 63/185,557, filed on May 7, 2021.

(51) Int. Cl. A47J 31/20; A47J 31/44; A47J 31/46; A47J 31/06; A47J 31/52

(52) U.S. Cl. CPC A47J 31/20; A47J 31/4407; A47J 31/468; A47J 31/06; A47J 31/52

(57) ABSTRACT

A system to brew a liquid is provided. The system includes a container with a brewing chamber, which receives a volume of liquid to allow for extracting a soluble substance to form a solution within the liquid. A basket is configured to be received within an internal volume of the container, the basket includes an upper sealing region and an extended portion, the extended portion includes a plurality of holes therethrough. A lid rests upon an upper surface of the container, the lid includes a center hole therethrough, the upper sealing region of the basket rests upon the lid. An assembly is removably mounted with respect to the basket, the assembly comprises a pump, suction inlet, and a fluid outlet, wherein the suction inlet is fluidly connected to a suction of the pump and the fluid outlet is fluidly connected to the outlet of the pump.

### CROSS-REFERENCE TO RELATED APPLICATIONS

This application claims priority from U.S. Provisional Application No. 63/185,557, filed on May 7, 2021, the entirety of which is fully incorporated by reference herein.

### BACKGROUND

The following disclosure is directed to systems for cold brewing a liquid such as coffee, but is applicable for any system for extracting a soluble substance from a volume of the substance to form a solution with a desired range of concentrations of the soluble substance within the liquids. The system has been experimentally determined to dramatically increase the speed of preparing a liquid with a desired concentration over conventional ways of preparing a liquid.

### BRIEF SUMMARY

A first representative embodiment of the disclosure is provided. The embodiment includes a system to brew a liquid. The system includes a container with a brewing chamber, which is configured to receive a volume of liquid to allow for extracting a soluble substance disposed within a basket to form a solution within the liquid. The basket is received within an internal volume of the container, the basket includes an upper sealing region and an extended portion, the extended portion includes a plurality of holes therethrough. A lid rests upon an upper surface of the container, the lid includes a center hole therethrough, the upper sealing region of the basket rests upon the lid. An assembly is removably mounted with respect to the basket, the assembly comprises a pump, suction inlet, and a fluid outlet, wherein the suction inlet is fluidly connected to a suction of the pump and the fluid outlet is fluidly connected to the outlet of the pump, wherein the fluid outlet directs fluid to flow into the basket.

Further embodiments of the disclosure are described in the Numbered Paragraphs below.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a perspective view of a system for brewing a liquid, depicting the container, the lid, the basket, and the pump assembly.

FIG. 2 is an exploded view of the system of FIG. 1, depicting the container, a filter bag, the basket, the pump assembly, and an optional support.

FIG. 3 is a perspective sectional view of the system of FIG. 1 depicting the bag positioned within the basket.

FIG. 4 is a perspective sectional view of the system of FIG. 1 with no bag positioned within the basket.

FIG. 5 is a sectional view of the container and basket.

FIG. 6 is a view of the pump assembly as well as portion of the intake tube.

FIG. 7 is a perspective sectional view of detail Z of FIG. 3, including the optional support.

FIG. 8 is a front sectional view of the view of FIG. 7.

FIG. 9 is a perspective view of a top portion of the basket of the system of FIG. 1.

FIG. 10 is a perspective view of the top of the extended portion of the basket and the flanges that mate with cavities in the upper sealing portion.

FIG. 11 is a perspective sectional view of the upper sealing portion depicting the cavities.

FIG. 12 is another perspective sectional view of the upper sealing portion depicting the cavities.

### DETAILED DESCRIPTION OF THE PREFERRED EMBODIMENTS

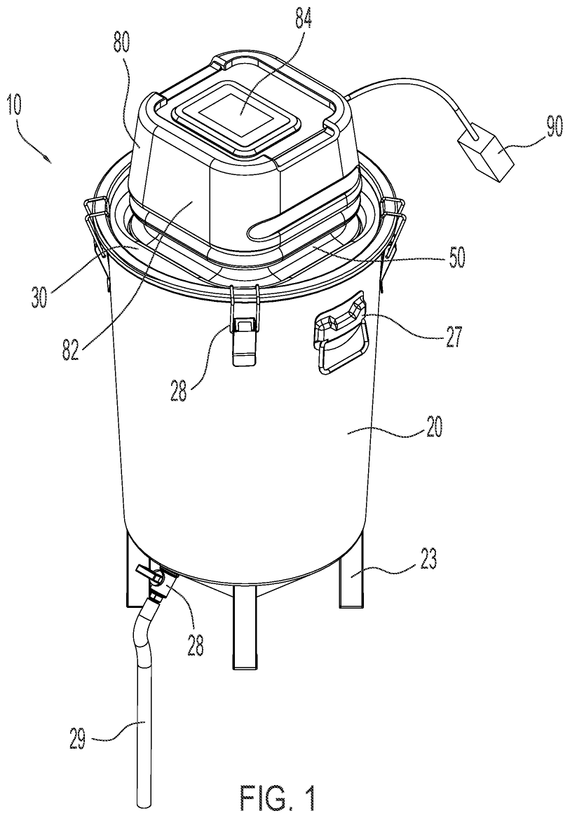

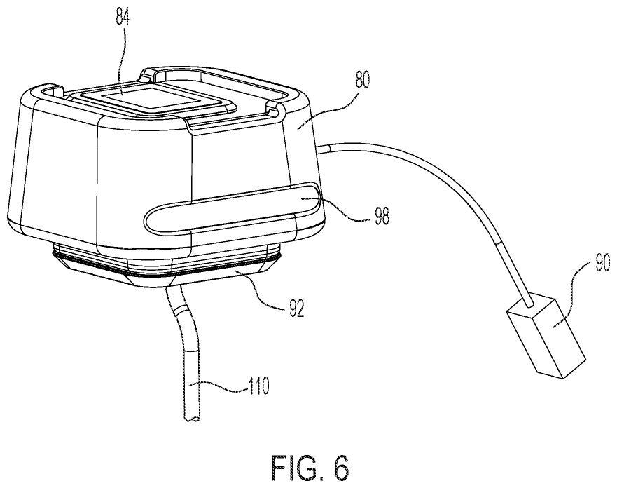

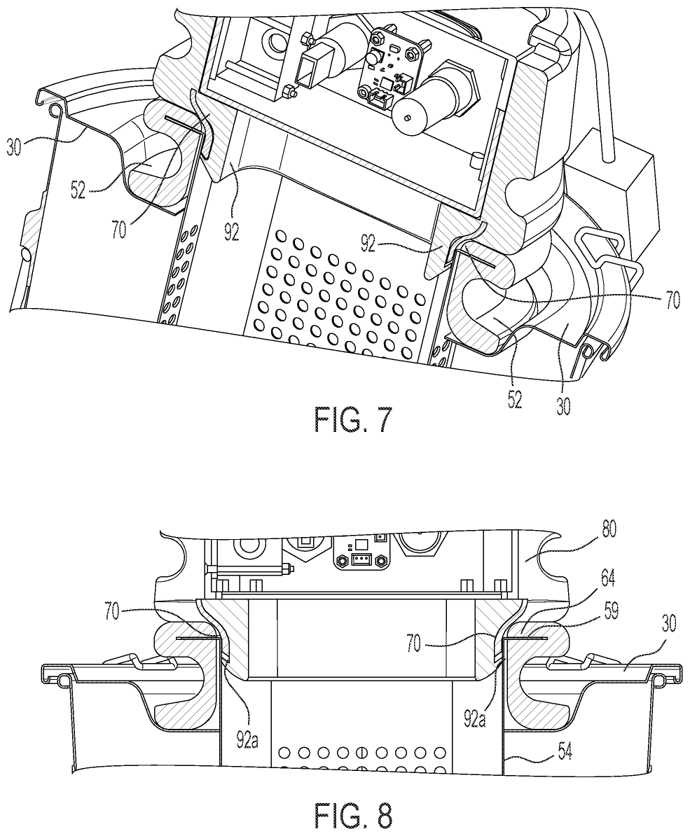

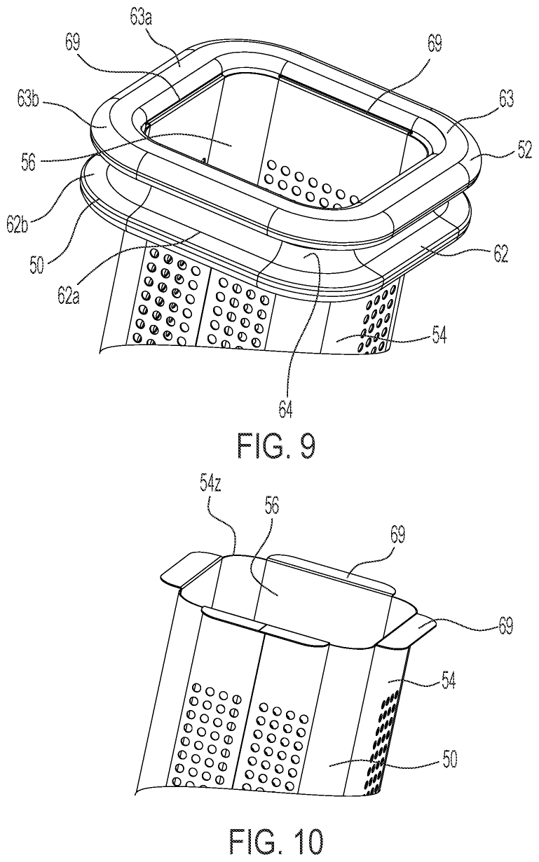

Turning now to FIGS. 1-13, a system for brewing a liquid 10 is provided. The system is configured to allow for extracting soluble substance from a volume of the substance to form a solution with a desired range of concentrations of the soluble substance within the liquid. In a preferred embodiment, the system is specifically configured to allow for “cold brew” of coffee from coffee grounds and has experimentally been determined to vastly accelerate the speed that coffee flavor (when used as a solute) is added to water (when used as a solvent) than is available with a system that operates with passive cold brewing, specifically, having coffee grounds within a container with liquid that is not pumped or urged in some forced manner to flow past the coffee grounds on a repeated basis. For example, using the system disclosed herein, the taste profile (i.e. the concentration of coffee flavor in the water) has been determined to be the same when the system 10 is used for 2-3 hours than when generating cold brew coffee passively for about 24 hours. While the system 10 is disclosed herein specifically for use with preparing cold brew coffee from coffee grounds, other flavored liquids can be used, such as tea prepared from tea leaves or tea grounds, or other flavored liquids.

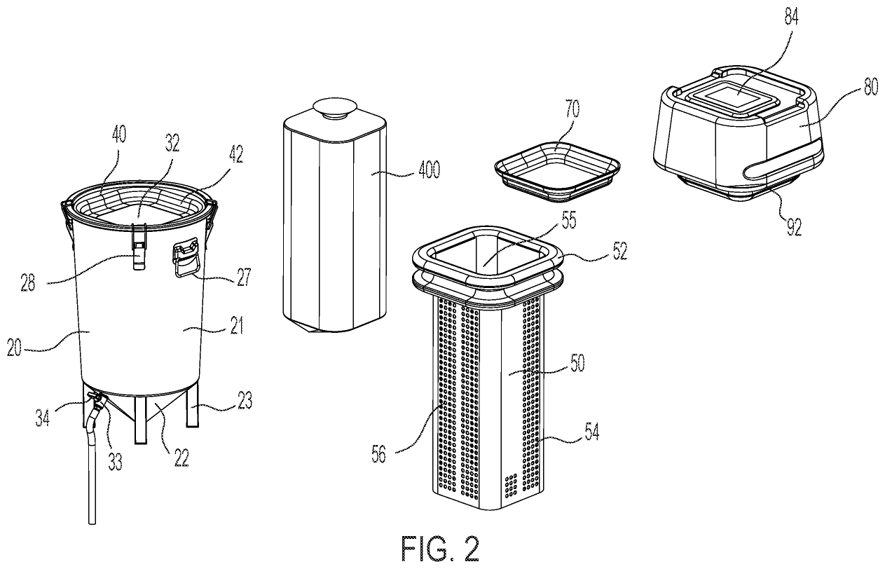

The system 10 is best understood with reference to FIGS. 1 and 2. The system 10 includes a container 20, a basket 50, a lid 40, and a pump assembly 80, each of which are described below in detail. The container 20 includes a volume for receipt and storage the liquid that is used to create the final brewed solution. The container 20 includes a top edge that receives a lid 40 thereon. The container may include a valve (or spout) 33 proximate or at the bottom of the container 20, with an operator 34 to control the valve to maintain the valve shut or allow the valve to open, to allow liquid that is within the container 20 to flow therethrough. In some embodiments, the valve 33 may be connected to an agitator 35 that is located within the internal volume of the container 20. In this embodiment, the valve 33 may be rotated by a user (either directly or by way of the operator 34) which similarly rotates the operator 35 within the container, thereby causing mixing or movement of the liquid within the container 20. The container 20 may be supported with a plurality of legs 23, that provide a set off distance from the container from the surface that the container 20 rests upon.

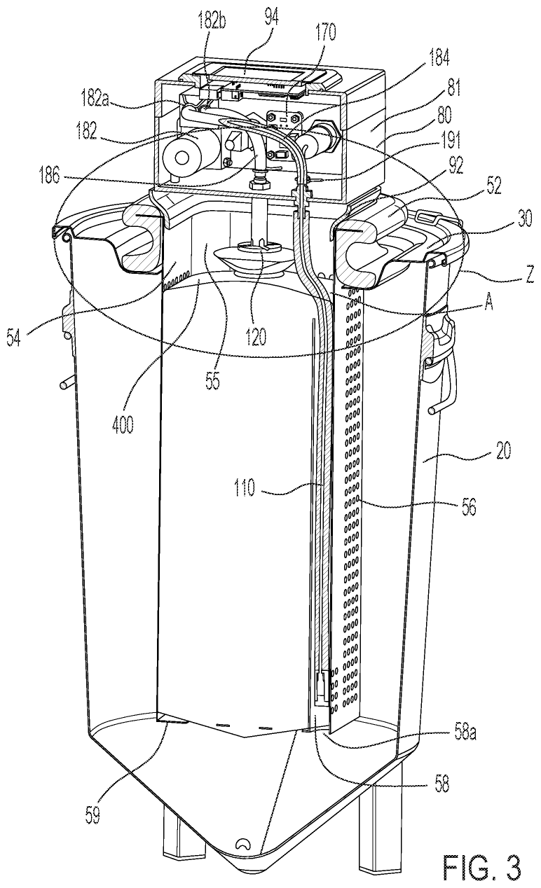

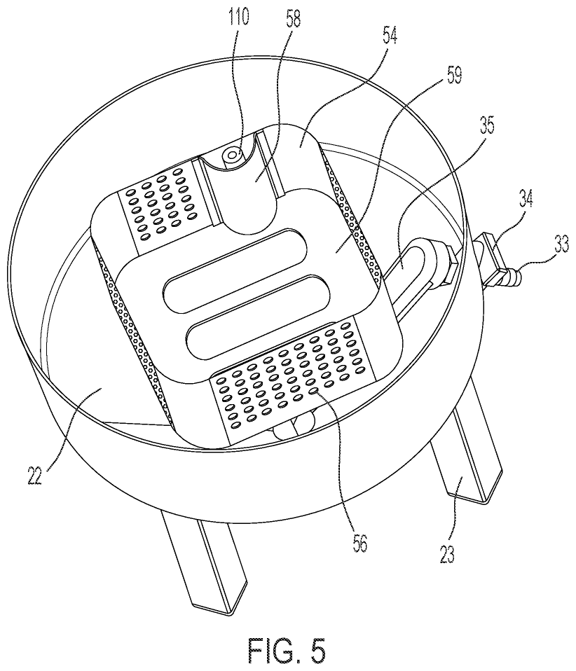

In some embodiments, the container 20 may include a side portion 21 and a bottom portion 22. The bottom portion 22 may be conical, or may be truncated conical with the truncated portion that faces downward. The bottom of the bottom portion 22 may include a drainage port. The side portion 21 may be truncated conical or may be cylindrical. The container 20 may include one or more handles 28. The inner volume 32 of the container 20 is configured to retain a volume of liquid as well as the basket 50 disposed therein. In some embodiments, the basket 50 when received within its normal position with respect to the container (and in some embodiments resting upon the lid 40, as discussed below) the basket 50 is positioned above the bottom portion 22 of the container as depicted in FIGS. 3 and 5. In other embodiments, a lower portion and a bottom plate 59 of the basket may be disposed in registry with the bottom portion 22 of the container 20. In embodiments where the container includes an agitator 35, the placement of the basket 50 in its normal position does not interfere with the motion of the agitator 35.

A lid 40 is best shown in FIGS. 1-4 and 7-8. The lid may include a resting portion 43 that is configured to rest upon the container 20, such as an upper edge 20a of the container 20. Alternatively, the lid 40 can rest upon (which includes upon and with respect to the container in a situation where the lid 40 does not directly contact the container) the container 20, such as upon a shelf disposed an inner surface or an outer surface (or the combination of the two) of the container 20. The lid 40 includes and aperture 42 that allows for access into the inner volume 32 of the container when the lid 40 is in its normal position. In some embodiments, the aperture 42 may be a square shape, including a geometric square, or a square shape with four straight sides but with arcuate corners in place of corners formed by the straight sides meeting at 90 degree angles as with the geometric square. The lid 40 may be a planar surface, or as best shown in FIG. 2, the lid may have inclined surface (either a constant incline as in a conical surface, a curved surface, or at a surface that changes heights, such as stair stepped) between the resting portion 43 and the aperture 43. In this embodiment, the aperture 42 extend through a plane that is below the upper edge 20a of the container.

The basket 50 is removably received upon the lid 40 and supports a bag 400 that may be filled with a soluble substance, such as coffee grounds, tea leaves, and the like. The basket 50 includes an upper sealing portion 52 and an extended portion 54. The extended portion 54 may be the size and shape as the aperture 42 in the lid 40 so that the extended portion 54 extends through the aperture. The extended portion 54 may include a plurality of walls that extend between an open end 54a and a bottom 59. The walls may each include a plurality of openings 56, which may be round holes or apertures of different shapes. The openings 56 are provided to allow liquid to flow therethrough, normally in a direction from within an internal volume of the basket 50 and out of the basket into the volume of the container 20 outside of the basket 50. As discussed in detail below, the liquid flow through the openings 56 is urged by the pump 182 that is provided within the assembly 80, as well as the flow of liquid into the volume within the extended portion 54 via the fluid outlet 120, which is positioned in registry with the volume of the extended portion 54 when installed.

The extended portion 54 of the basket 50 further may include a retainer 58 that is fixed to a side wall portion of the extended portion, which receives and supports an intake tube 110, which is fluidly connected to the suction inlet of the assembly and ultimately to a suction 182a of the pump 182. The bottom 59 of the basket may include an aperture 59a that is aligned with the retainer 58 that allows liquid to flow therethrough and into the intake tube 110. In other embodiments, liquid may flow into the intake tube 110 through an aperture in a side wall portion of the extended portion that communicates with the intake tube 110. The bottom 59 of the basket 50 may include a plurality of apertures or may be solid. The bag 400 that is received within the basket 50 may rest upon the bottom 59 of the basket 50.

The basket 50 further includes an upper sealing portion 52 that is disposed at a top portion thereof and surrounds the open end 54a of the extended portion 54. The upper sealing portion 52 may include a first sealing portion 62, a second sealing portion 63, and a bridging portion 65 between the two sealing portions. The first sealing portion 62 is disposed in contact with the extended portion 54 and extends radially outward from the extended portion around an entire perimeter of the extended portion 54. The first sealing portion 62 establishes an outer perimeter. The second sealing portion 63 is disposed above the first sealing portion and establishes an outer perimeter. In some embodiments, the outer perimeter of the second sealing portion 63 is the same as the outer perimeter of the first sealing portion 62.

In a preferred embodiment, the first and second sealing portions 62, 63 are disposed in an approximately square perimeter, which includes four sides that are straight 62a and four arcuate portions 62b that transition between the four straight portions, such that the straight portions 62a and the arcuate portions 62b are disposed in an alternating manner. The term approximately is defined to mean a shape with four straight portions 62a that are about the same length that are disposed at about 90 degree angles with each other with the corners of a geometric square replaced with arcuate portions. The term about is defined to include a range of dimensions or angles that is plus or minus 5% of the nominal dimension or angle.

In some embodiments the first and second sealing portions 62, 63 have a nominal outer perimeter size and shape that are each the same or about the same and/or a nominal inner perimeter size and shape that are the same or about the same.

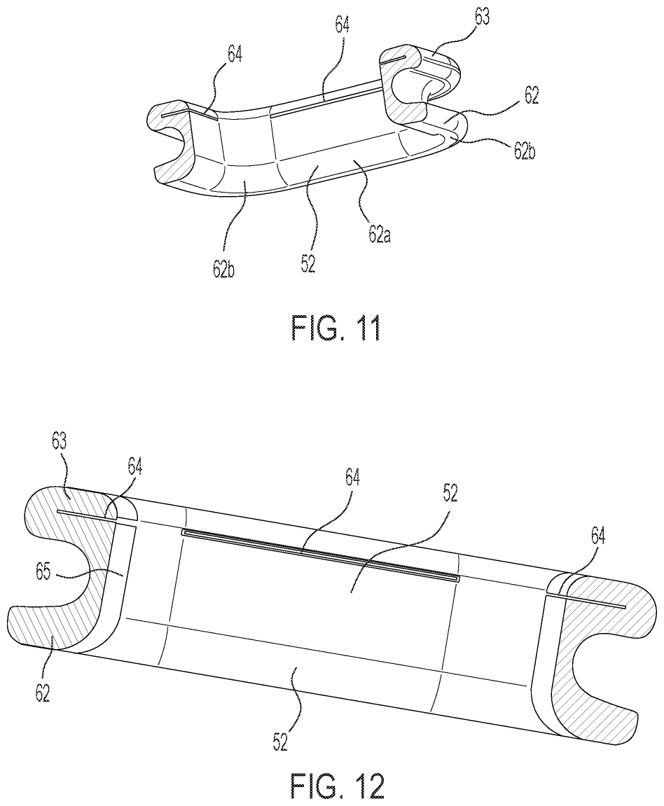

The bridging portion 65 connects the first and second sealing portions 62, 63. In some embodiments, the bridging portion has a thinner outer perimeter than the first and second sealing portions 62, 63, which allows the second sealing portion 63 to compress toward the first sealing portion 62 when a downward force is applied to the top surface of the upper sealing portion 63. In some embodiments, the bridging portion 65 may have a constant cross-section along its perimeter. In some embodiments, the bridging portion 65 may have a constant perimeter along its height (i.e. generally planar outer walls) while in other embodiments the perimeter of the bridging portion may be arcuate about its height (curved outer walls). In some embodiments as shown in FIGS. 11 and 12, the profile of the outer perimeter of the bridging portion 65 may be continuous with the curve that transitions to the bridging portion 65 from curves that form the outer surface of one or both of the first and second sealing portions 62, 63. In some embodiments, the inner surface (i.e. the surface that forms the aperture within the upper sealing portion 52 and that contacts the extended portion 54) may be planar (i.e. the same inner perimeter along the height of one or all three of the first and second sealing portions 62, 63 and the bridging portion 65).

In some embodiments, one of the first and second sealing portions 62, 63 includes an elongate cavity 64, or a plurality of elongate cavities 64. In the embodiment depicted in the figures the elongate cavities 64 (one on each straight portion) are disposed within the second sealing portions 63. The elongate cavities 64 are recesses or spaces in the respective sealing portion that receive a respective flange 69 that extends radially outward from the extended portion 54, such as in some embodiments, from the upper edge 54z of the extended portion. The receipt of the flanges 69 within the respective elongate cavities 64 fixes the two portions of the basket 50 together.

The assembly 80 is best depicted in FIG. 3. The assembly 80 includes a housing 81 that supports and encloses the mechanical components of the assembly, including the pump 182 and the controller, and pipes/tubes 184, 186 that lead from the suction inlet 97 to the suction 182a of the pump 182 and that lead from the discharge 182b of the pump 182 to the fluid outlet 99. The housing 81 also supports the controller 300, which is discussed below. The pump 182 and the controller 300 may be powered from AC current through a cable and conventional plug 90, or alternatively, the pump and controller may be powered by batteries. In some embodiments, the housing 81 may be plastic or metal or another rigid material, and may be surrounded by an outer material, such as an elastomeric material.

The assembly 80 includes a diffuser 120 that is positioned below the housing 81 and is fluidly connected to the discharge of the pump 182. The diffuser 120 separates the liquid flowing from the pump 182 into different streams, such as a conventional shower head. In some embodiments, the diffuser may release one or more rings of liquid that extends outward from the diffuser in a conical fashion, while in other embodiments, the diffuser 120 may release a plurality of lines of water in various directions. The diffuser 120 is provided to increase the surface area of the top of the bag 400 that the liquid discharged from the pump engages the bag, to increase the surface area of soluble material that is interacted with by the liquid.

The pump 182 draws suction from a intake tube 110 that extends within the container 20 to draw into the pump liquid that is from the container 20 and outside the basket 50. Operation of the pump 182 causes liquid to flow from the container 20, through the intake tube 110 (which extends through the basket 50 but liquid in the intake tube 110 does not interact in that flow path with liquid within the basket 50 and into the pump 182. Liquid is discharged from the pump 182 extends through the diffuser and is directed onto the bag (or directly into the bag 400 if the bag is open). In embodiments where liquid is directed onto the bag 400, the porous nature of the bag allows liquid to flow through the walls of the bag and flow against the soluble material within the bag, thereby causing the liquid to carry a higher concentration of the soluble material with each pass and with continued flow increasing the concentration of the soluble material within the liquid. The flow urged by the pump 182 also mixes the liquid within the container 20 over time such that the liquid establishes a uniform concentration after a sufficient time of pump operation.

In some embodiments, the intake tube 110 has a filter 118 disposed at the open bottom end which mechanically prevents particles (above greater than the filter gage) from flowing into intake tube 110 and to the pump 182.

The housing 81 further supports a display 94 and an input device 94a thereon. In some embodiments, a top surface of the housing may support the display and input device 94a such that a user viewing the assembly 80 from above can view the display 94 and interact with the input device 94a from above the assembly 80.

In some embodiments the display 94 and input device 94a may be the same component, such as a touch screen.

The controller 300 includes a processor and a non-volatile memory. In some embodiments, the controller may be a microcontroller with a CPU, a memory and input and output peripherals. The controller 300 communicates with the display 94 and the input device 94a as well as with the pump 182, which causes pump operation at desired or designated times and durations. In embodiments where the container 20 and/or the basket 50 includes one or more sensors 302 (discussed below), the controller 300 receives signals from the one or more sensors.

The controller 300 may be programmed, via the non-volatile memory to operate the pump 182 based upon one or more recipes, which are routines to operate the pump 182 (thereby causing liquid movement through the basket 50 and container 20 as discussed below) for various time durations as well as cyclically for various repeated on and off durations. The controller may operate the display 94 to prompt the user to select a desired recipe, with the user manipulating the input device 94a to input their desired recipe. Upon receipt of the desired recipe the controller 300 operates the pump for the durations per the recipe. In embodiments where the pump 182 is a variable speed pump, the controller 300 operates the pump based upon the pump speed per the recipe.

In some embodiments, the controller 300 may also operate the pump 182 manually, such as with an on/off controls on the input device 94a. The controller may also receive a command to operate the pump 182 for a set period of time, either with the pump starting immediately or with the pump starting after a set delay time. The user may provide a command for the desired pump speed via the input device.

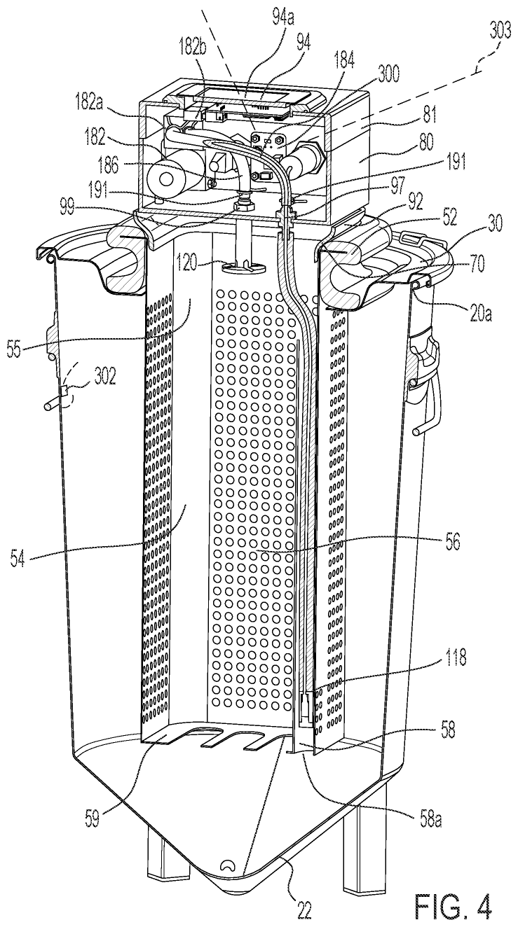

In embodiments, where sensors 302 are provided, the sensors (302, FIG. 4 (schematic)) may provide a signal to the controller that is representative of the concentration of a solute within the solvent, such as a the concentration of coffee within the liquid within the container 20. In other embodiments, the sensor 302 may provide a temperature signal to the controller. In these embodiments the signals (such as concentration and temperature) are used by the controller to operate the pump 182 to obtain a desired liquid after the recipe, such as with feedback control. One of ordinary skill in the art after a thorough review of this specification would be capable of designing a recipe for the controller 300 to operate the pump based upon data received from the sensor 302 without undue experimentation.

In some embodiments, the controller 300 may be capable of communicating with an external input device (not shown—but signal depicted schematically as 303 on FIG. 4). The external input device may be a smart phone, a tablet, a computer, or dedicated input device, which may communicate with the controller over a hard wired connection, or via a wireless connections such as Bluetooth, Wi-Fi, a cellular connection, and the like.

The system is configured to receive a volume of a soluble substance, such as coffee grounds, or tea leaves, or cut fruits within the basket 50, which may be received within a bag 400. The bag may be made from a porous fabric or mesh that allows liquid to flow through the walls of the bag, but prevents the soluble material from passing through the walls. In a preferred embodiment, the bag 400 is retained within the basket 50 in a closed orientation, such as closed with a draw string or a zip tie to prevent the soluble material from spilling into the container. In embodiments, that include a support 70 (FIG. 2), the support 70 may rest upon the upper sealing region 52 of the basket with the transition portion 92 resting upon the support 70. The bag 400 in this embodiment may be open with the upper portion of the bag extending above and against the outer surface of the support 70 such that the bag 400 is maintained between the support 70 and the upper sealing region 52, which maintains the bag 400 in the open position due to the force caused by the transition portion 92 of the assembly 80 pressing against the support 70. In other embodiments, the support 70 is not needed and the transition portion 92 rests directly upon the upper sealing region 52 of the basket 50.

The transition portion 92 may include a ledge 92a (FIG. 8) that extends radially outward from the outer perimeter and specifically from an outer surface of the transition portion preferably at or proximate to a lower portion of the transition portion 92. The ledge 92a may extend to an outer perimeter that is slightly larger than the size and shape of the inner walls of the extended portion 54 of the basket, such that when the transition portion 92 is positioned within the extended portion 54, the ledge 92a presses into the surface of the extended portion 54 to establish an interference fit between the transition portion 92 and ultimately the assembly 80 and the basket 50.

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The subject disclosure is exemplified by the following numbered paragraphs:

Numbered Paragraph 1: A system to brew a liquid, comprising:

a container with a brewing chamber, which is configured to receive a volume of liquid to allow for extracting a soluble substance disposed within a basket to form a solution within the liquid;

the basket that is configured to be received within an internal volume of the container, the basket includes an upper sealing region and an extended portion, the extended portion includes a plurality of holes therethrough;

a lid that rests upon an upper surface of the container, the lid includes a center hole therethrough, the upper sealing region of the basket rests upon the lid;

an assembly that is removably mounted with respect to the basket, the assembly comprises a pump, suction inlet, and a fluid outlet, wherein the suction inlet is fluidly connected to a suction of the pump and the fluid outlet is fluidly connected to the outlet of the pump, wherein the fluid outlet directs fluid to flow into the basket.

Numbered Paragraph 2: The system of Numbered Paragraph 1, wherein the assembly is an enclosed assembly such that the assembly is configured to be installed upon and rest with respect to the lid and in registry with the center hole, such that the suction inlet and the fluid outlet both extend through the hole in the lid.

Numbered Paragraph 3: The system of Numbered Paragraph 1, wherein the suction inlet is connected to an intake tube that extends through the basket.

Numbered Paragraph 4: The system of Numbered Paragraph 3, wherein the basket includes a retainer fixed with respect to a side wall of the basket and disposed within the internal volume of the basket, wherein the retainer receives the intake tube therein and directs the intake tube toward an aperture in the basket.

Numbered Paragraph 5: The system of any one of Numbered Paragraphs 1-4, wherein the basket further comprises a flexible sealing portion within the upper sealing region, the flexible sealing portion includes an elastomeric material.

Numbered Paragraph 6: The system of Numbered Paragraph 5, wherein the flexible sealing portion comprises a first sealing portion and a second sealing portion and a bridging portion, the first sealing portion is disposed in contact with the extended portion and extends radially outward from the extended portion around an entire perimeter of the extended portion and establishes a first outer perimeter of the first portion, the second sealing portion is disposed above the first sealing portion and establishes a second outer perimeter that is the same as the first outer perimeter, the bridging portion having a cross-section that is narrower than a cross-section of both of the first and second sealing portions such that when a downward force is applied to the second sealing portion the bridging portion bends to allow the second sealing portion to move toward the first sealing portion.

Numbered Paragraph 7: The system of Numbered Paragraph 6, wherein the first sealing portion and the second sealing portion each have four arcuate portions and four straight portions with the arcuate portions and straight portions disposed in an alternating fashion to establish a square shape with curves instead of corners.

Numbered Paragraph 8: The system of Numbered Paragraph 7, wherein one or more of the four straight portions of the second sealing portion includes an elongate cavity that extends a portion of the length of the respective straight portion, wherein the basket includes a respective one or more flanges that extend radially outward from a side wall of the extended portion in registry with the respective one or more straight portions that include the elongate cavity, wherein each of the flanges extend within the respective elongate cavities.

Numbered Paragraph 9: The system of any one of Numbered Paragraphs 1-8, wherein the assembly includes a top surface which faces upwardly when the assembly is mounted upon the lid, wherein the top surface includes a display and an input device that is adapted to allow a user to control operation of the pump.

Numbered Paragraph 10: The system of any one of Numbered Paragraphs 1-9, further comprising a controller that includes a processor and a non-volatile memory, wherein the controller is in communication with the display to control operation of the display and the controller is in communication with the input device such that operation of the input device provides signals to the controller which causes the controller to cause continuous or periodic operation of the pump.

Numbered Paragraph 11: The system of Numbered Paragraph 10, wherein the controller is configured to operate the pump at staggered times and durations based upon a recipe that is stored within the non-volatile memory.

Numbered Paragraph 12: The system of any one of Numbered Paragraphs 1-11, further comprising a support that rests upon the upper sealing region of the basket, the support includes four sides that collectively form a square shape with arcuate corners, the support comprising an angled side surface upon each side such that a top edge of the support along each of the four sides is radially outward from a lower inner edge along each of the four sides.

Numbered Paragraph 13: The system of Numbered Paragraph 12, wherein when a filter bag is installed within the system and within an internal volume of the extended portion, wherein an open end of the bag includes an upper portion that extends around a periphery of the filter bag, wherein the upper portion is disposed between the upper sealing portion and the support to constrain the filter bag within the internal volume of the extended portion.

Numbered Paragraph 14: The system of Numbered Paragraph 13, wherein the assembly includes a transition portion, the transition portion includes four sides that collectively form a square shape with arcuate corners, the transition portion extends within the extended portion of the basket and includes an outer surface that contacts the support when installed thereon, wherein a bottom portion of the transition portion includes a ledge that extends radially outward, wherein when installed upon the support the ledge is positioned below a lower edge of support.

Numbered Paragraph 15: The system of any one of Numbered Paragraphs 1-13, wherein the assembly includes a transition portion, wherein the transition includes four sides that collectively form a square shape with arcuate corners, wherein when the assembly is mounted with respect to the basket the transition extends within an open volume of the upper sealing region.

Numbered Paragraph 16: The system of Numbered Paragraph 15, wherein the transition portion includes a ledge that extends radially outward along the perimeter of the transition portion, wherein the ledge extends to an outer perimeter that is slightly larger than an inner perimeter of the extended portion of the basket, such that the ledge makes an interference fit with the basket when the transition region extends within the basket.

Numbered Paragraph 17: The system of Numbered Paragraph 16, wherein the assembly includes a top surface which faces upwardly when the assembly is mounted upon the lid, wherein the top surface includes a display and an input device that is adapted to allow a user to control operation of the pump.

Numbered Paragraph 18: The system of Numbered Paragraph 17, further comprising a controller that includes a processor and a non-volatile memory, wherein the controller is in communication with the display to control operation of the display and the controller is in communication with the input device such that operation of the input device provides signals to the controller which causes the controller to cause continuous or periodic operation of the pump.

1. A system to brew a liquid, comprising:
a container with a brewing chamber, which is configured to receive a volume of liquid to allow for extracting a soluble substance disposed within a basket to form a solution within the liquid;
the basket is configured to be received within an internal volume of the container, the basket includes an upper sealing region and an extended portion, the extended portion includes a plurality of holes therethrough;
a lid that rests upon an upper surface of the container, the lid includes a center hole therethrough, the upper sealing region of the basket rests upon the lid;
an assembly that is removably mounted with respect to the basket, the assembly comprises a pump, suction inlet, and a fluid outlet, wherein the suction inlet is fluidly connected to a suction of the pump and the fluid outlet is fluidly connected to the outlet of the pump, wherein the fluid outlet directs fluid to flow into the basket.

2. The system of claim 1, wherein the assembly is an enclosed assembly such that the assembly is configured to be installed upon and rest with respect to the lid and in registry with the center hole, such that the suction inlet and the fluid outlet both extend through the hole in the lid.

3. The system of claim 1, wherein the suction inlet is connected to an intake tube that extends through the basket.

4. The system of claim 3, wherein the basket includes a retainer fixed with respect to a side wall of the basket and disposed within the internal volume of the basket, wherein the retainer receives the intake tube therein and directs the intake tube toward an aperture in the basket.

5. The system of claim 2, wherein the basket further comprises a flexible sealing portion within the upper sealing region, the flexible sealing portion includes an elastomeric material.

6. The system of claim 5, wherein the flexible sealing portion comprises a first sealing portion and a second sealing portion and a bridging portion, the first sealing portion is disposed in contact with the extended portion and extends radially outward from the extended portion around an entire perimeter of the extended portion and establishes a first outer perimeter of the first portion, the second sealing portion is disposed above the first sealing portion and establishes a second outer perimeter that is the same as the first outer perimeter, the bridging portion having a cross-section that is narrower than a cross-section of both of the first and second sealing portions such that when a downward force is applied to the second sealing portion the bridging portion bends to allow the second sealing portion to move toward the first sealing portion.

7. The system of claim 6, wherein the first sealing portion and the second sealing portion each have four arcuate portions and four straight portions with the arcuate portions and straight portions disposed in an alternating fashion to establish a square shape with curves instead of corners.

8. The system of claim 7, wherein one or more of the four straight portions of the second sealing portion includes an elongate cavity that extends a portion of the length of the respective straight portion, wherein the basket includes a respective one or more flanges that extend radially outward from a side wall of the extended portion in registry with the respective one or more straight portions that include the elongate cavity, wherein each of the flanges extend within the respective elongate cavities.

9. The system of claim 1, wherein the assembly includes a top surface that faces upwardly when the assembly is mounted upon the lid, wherein the top surface includes a display and an input device that is adapted to allow a user to control operation of the pump.

10. The system of claim 9, further comprising a controller that includes a processor and a non-volatile memory, wherein the controller is in communication with the display to control operation of the display and the controller is in communication with the input device such that operation of the input device provides signals to the controller which causes the controller to cause continuous or periodic operation of the pump.

11. The system of claim 10, wherein the controller is configured to operate the pump at staggered times and durations based upon a recipe that is stored within the non-volatile memory.

12. The system of claim 1, further comprising a support that rests upon the upper sealing region of the basket, the support includes four sides that collectively form a square shape with arcuate corners, the support comprising an angled side surface upon each side such that a top edge of the support along each of the four sides is radially outward from a lower inner edge along each of the four sides.

13. The system of claim 12, wherein when a filter bag is installed within the system and within an internal volume of the extended portion, wherein an open end of the bag includes an upper portion that extends around a periphery of the filter bag, wherein the upper portion is disposed between the upper sealing portion and the support to constrain the filter bag within the internal volume of the extended portion.

14. The system of claim 13, wherein the assembly includes a transition portion, the transition portion includes four sides that collectively form a square shape with arcuate corners, the transition portion extends within the extended portion of the basket and includes an outer surface that contacts the support when installed thereon, wherein a bottom portion of the transition portion includes a ledge that extends radially outward, wherein when installed upon the support the ledge is positioned below a lower edge of the support.

15. The system of claim 1, wherein the assembly includes a transition portion, wherein the transition includes four sides that collectively form a square shape with arcuate corners, wherein when the assembly is mounted with respect to the basket the transition extends within an open volume of the upper sealing region.

16. The system of claim 15, wherein the transition portion includes a ledge that extends radially outward along the perimeter of the transition portion, wherein the ledge extends to an outer perimeter that is slightly larger than an inner perimeter of the extended portion of the basket, such that the ledge makes an interference fit with the basket when the transition region extends within the basket.

17. The system of claim 16, wherein the assembly includes a top surface which faces upwardly when the assembly is mounted upon the lid, wherein the top surface includes a display and an input device that is adapted to allow a user to control operation of the pump.

18. The system of claim 17, further comprising a controller that includes a processor and a non-volatile memory, wherein the controller is in communication with the display to control operation of the display and the controller is in communication with the input device such that operation of the input device provides signals to the controller which causes the controller to cause continuous or periodic operation of the pump.
